(19) United States
(12) Patent Application Publication
(10) Pub. No.: US 2002/0014721 A1
(43) Pub. Date: Feb. 7, 2002

(54) Method of producing a high-strength component from plastic, and a high-strength component

(76) Inventor: Friedhelm Beckmann, Hiddenhausen (DE)

Correspondence Address: LERNER AND GREENBERG, P.A., Post Office Box 2480, Hollywood, FL, 33022-2480, US

(21) Appl. No.: 09/901,430

(22) Filed: Jul. 9, 2001

Related U.S. Application Data
(63) Continuation of application No. PCT/DE99/03652, filed on Nov. 15, 1999.

(30) Foreign Application Priority Data
Jan. 7, 1999 (DE) 199 00 233.9

(51) Int. Cl. B29C 45/14

(52) U.S. Cl. 264/259

(57) ABSTRACT

Two materials with different strength properties are bonded to one another to give a composite, in a mold which serves for shaping. The bond between the two materials may be produced by chemical/physical bonding mechanisms and/or external profiling, in particular by undercuts. The bonding may be substantially promoted by utilizing the intrinsic heat in one material.

### CROSS-REFERENCE TO RELATED APPLICATION

This is a continuation of copending International Application PCT/DE99/03652, filed Nov. 15, 1999, which designated the United States.

### BACKGROUND OF THE INVENTION

### Field of the Invention

The invention lies in the field of plastics fabrication and relates, more specifically, to a method of producing a high-strength component from plastic, using materials which raise strength, in particular using fiber materials, as well as to a high-strength component made from plastic.

The large-scale use of high-strength components made from plastic requires that suitable measures be taken to stabilize those regions of the component that are subject to extreme loads, and that some of the mechanical properties are matched to these high requirements. An example of a use of components of this type are seat shells in motor vehicles. There, they are exposed to extreme loads in terms of flexural stiffness and impact strength, at various temperatures. In order to meet these high requirements, components of this type are produced from reinforced thermoplastic molding compositions.

Examples of the reinforcing materials used here are glass fibers, carbon fibers and other fibrous reinforcements. However, with respect to the abovementioned properties, these fiber materials have to have a balanced relationship between mechanical properties and the need for lightweight construction. Another factor to be taken into account here is that thermoplastic materials are preferable to thermosets for reasons of recycling, and the use of reinforcing fibers is limited here by the increase in weight.

### SUMMARY OF THE INVENTION

The object of the present invention is to provide a method of producing a heavy-duty plastic component and such a component which overcome the above-noted deficiencies and disadvantages of the prior art devices and methods of this general kind, and which provide for the low-cost manufacture of composites which can accept extreme loads and also have lower weight than conventional components.

With the above and other objects in view there is provided, in accordance with the invention, a method of producing a plastic component, which comprises: placing a first, high-strength material into a shaping mold;

introducing a second material having a lesser strength than the first material into the mold with a process selected from the group consisting of casting and injection molding; and

bonding the first and second materials to a composite and thereby maintaining in the first material a given amount of specific heat or residual heat when the second material is introduced.

In accordance with an added feature of the invention, fiber materials are incorporated in the materials for raising a structural strength of the plastic component.

In accordance with an additional feature of the invention, a region of the mold is screened off with a slide and the first material is molded in the screened-off region, and after pulling the slide and a cooling period, the second material is bonded to the first material, while the first material still contains residual heat.

In accordance with another feature of the invention, the method comprises inserting a prefabricated component formed of the first material with a given amount of residual heat, and subsequently bonding the second material to the first material. The high-strength component of the first material may be formed with ribbing and/or a hollow portion.

In accordance with again another feature of the invention, the hollow portion may be formed by pressing an inert gas into the first material when the first material is still in a plastic phase.

With the above and other objects in view there is also provided, in accordance with the invention, a component made from plastic, comprising:

a component body formed with a first, high-strength material and a second material of lesser rigidity than the first material;

reinforcing fiber materials incorporated into the component body for raising a strength of the component body; and

wherein the first and second materials are bonded to form the component body on effect of an internal heat of the first and second materials or of an external profiling.

In accordance with a concomitant feature of the invention, the external profiling is formed by undercuts.

According to the invention, this object is achieved in that two materials with different strength properties are bonded to give a composite, in the mold which serves for shaping, where the bond between the two materials is produced by utilizing the residual heat in one of the materials. In one preferred process, a region in the mold which serves for shaping is screened off by a slide, and a high-strength material is introduced into this screened-off region, and, after a cooling period, the slide is closed, and, in a subsequent operation, a material with lower strength is introduced into the free space of the remaining mold cavity.

There is also the possibility of inserting a prefabricated component into the higher-strength region, wherein case, if appropriate, the prefabricated component is provided with a prescribed level of enthalpy prior to the introduction of the second material. This enthalpy substantially promotes the bonding between the two regions. The component formed by the higher-strength material may be provided with ribbing and/or with a hollow portion, to reduce weight, where the hollow portion is advantageously formed by the internal gas pressure process, during which an inert gas is injected into the material while it is still in its plastic state.

The high-strength component of the invention, made from plastic, may comprise materials which raise strength, in particular fiber materials, where two materials with different strength properties are bonded to give a composite. The bond between the two materials is due to chemical/physical bonding mechanisms and/or external profiling, in particular by undercuts.

I claim:

1. A method of producing a plastic component, which comprises:
placing a first, high-strength material into a shaping mold;
introducing a second material having a lesser strength than the first material into the mold with a process selected from the group consisting of casting and injection molding; and
bonding the first and second materials to a composite and thereby maintaining in the first material a given amount of specific heat or residual heat when the second material is introduced.

2. The method according to claim 1, which comprises incorporating fiber materials in the materials for raising a structural strength of the plastic component.

3. The method according to claim 1, which comprises screening off a region of the mold with a slide and molding the first material in the screened-off region, and after pulling the slide and a cooling period, bonding the second material to the first material, while the first material still contains residual heat.

4. The method according to claim 1, which comprises inserting a prefabricated component formed of the first material with a given amount of residual heat, and subsequently bonding the second material to the first material.

5. The method according to claim 1, which comprises forming the first material as a component formed with ribbing.

6. The method according to claim 1, which comprises forming the first material as a component having a hollow portion.

7. The method according to claim 6, which comprises forming the hollow portion by pressing an inert gas into the first material when the first material is still in a plastic phase.

8. A component made from plastic, comprising:
a component body formed with a first, high-strength material and a second material of lesser rigidity than said first material;
reinforcing fiber materials incorporated into said component body for raising a strength of said component body; and
wherein said first and second materials are bonded to form said component body on effect of an internal heat of said first and second materials or of an external profiling.

9. The component according to claim 8, wherein the external profiling is formed by undercuts.
